(19) United States
(12) Patent Application Publication
(10) Pub. No.: US 2007/0121994 A1
(43) Pub. Date: May 31, 2007

(54) Speaker apparatus

(75) Inventors: Shinichi Hayasaka, Tendo-shi (JP); Hiroyuki Kobayashi, Tendo-shi (JP); Koji Takayama, Tendo-shi (JP)

Correspondence Address: DRINKER BIDDLE & REATH (DC), 1500 K STREET, N.W., SUITE 1100, WASHINGTON, DC, 20005-1209, US

(73) Assignees: Pioneer Corporation; Tohoku Pioneer Corporation

(21) Appl. No.: 11/601,844

(22) Filed: Nov. 20, 2006

(30) Foreign Application Priority Data
Nov. 21, 2005 (JP) P2005-336355

(51) Int. Cl. H04R 11/02

(52) U.S. Cl. 381/420; 381/412; 381/414

(57) ABSTRACT

A speaker apparatus comprises an inner magnet type magnetic circuit for driving a voice coil connected to a vibrating plate. The magnetic circuit comprises; a yoke; a magnet at least partly mounted at an inside of the yoke; a pole piece being attached to the other magnetized face of the magnet at the inside of the yoke; a repulsive magnet both faces being magnetized to polarities reverse to a polarity of the magnet and attached on a surface thereof of a vibrating plate side of the pole piece; and a short-circuit ring mounted and fitted to an inner peripheral portion of a front end of the cylinder portion of the yoke.

### CROSS-REFERENCE TO RELATED APPLICATIONS

This application is based on and claims the benefit of priority from the prior Japanese Patent Application No. 2005-336355, on Nov. 21, 2005; the entire contents of which are incorporated herein by reference.

### BACKGROUND

1. Technical Field

The present invention relates to a speaker apparatus, particularly relates to a speaker apparatus integrated with an inner magnet type magnetic circuit as a magnetic circuit for driving a voice coil connected to a vibrating plate.

2. Related Art

In recent years, in accordance with space saving formation of acoustic apparatus or the like, also according to a speaker apparatus mounted thereto, a request for small-sized light-weighted formation has been increased. For the small-sized light-weighted formation of the speaker apparatus, small-sized formation of a magnetic circuit for driving a vibrating plate is effective.

Magnetic circuits integrated to a speaker apparatus can roughly be classified into an outer magnet type for arranging a magnet on an outer side of a yoke and an inner magnet type for arranging a magnet on an inner side of a yoke. According to a magnetic circuit of an inner magnet type, in comparison with a magnetic circuit of an outer magnet type, leakage of magnetic flux to the outside can be restrained. Therefore, an efficiency thereof is excellent. The inner magnet type is advantageous for small-sized light-weighted formation.

According to related arts, a speaker apparatus further improves such an inner magnet type magnetic circuit shown by FIGS. 1 and 2.

JP-A-2003-199189 discloses a speaker apparatus 10 mentioned below. In a related-art speaker apparatus 10, a voice coil 4 is wound around an outer periphery of a voice coil bobbin 3 connected to an outer peripheral edge of a vibrating plate 2 of a dome type.

An inner magnet type magnetic circuit 6 for driving the voice coil 4 includes a pot yoke 8 (hereinafter, referred to as “a yoke 8”), a magnet 9, and a pole piece 11. The yoke 8 is made of a magnetic member formed in a pot type shape. The magnetic member includes a bottom plate portion 8a in a shape of a circular plate and a cylinder portion 8b extending an outer periphery of the bottom plate portion 8a in an axial direction of the vibrating plate 2. The magnet 9 is formed in a circular-plate shape. Both faces of the magnet 9 are magnetized, one magnetized face of the magnet 9 is closely attached to the bottom plate portion 8a. The pole piece 11 is made of a magnetic member, and has a circular-plate shape. The pole piece 11 is closely attached to other magnetizing face of the magnet 9. Magnetic gap s is formed between an outer peripheral portion of the pole piece 11 and the cylinder portion 8b of the yoke 8. The voice coil 4 is inserted into the magnetic gap s.

In the inner magnet type magnetic circuit 6, a short-circuit ring 13 formed by a metal of copper, aluminum or the like is fitted to be mounted to an outer peripheral portion of the pole piece 11 facing the magnetic gap s as an improvement measure for reducing magnetic distortion by nonlinearlity of a permeability.

JP-A-2002-78081 a speaker apparatus 20 as shown in FIG. 2, as mentioned below. A voice coil 24 is wound around an outer periphery of a voice coil bobbin 23 connected to an inner peripheral edge of a vibrating plate 22 of a cone type. An outer peripheral edge of the vibrating plate 22 is fixed to a speaker frame 26 by way of an edge 25. The voice coil bobbin 23 is connected to the speaker frame 26 movably in an axial direction of the vibrating plate 22 by a corrugation damper 27.

An inner magnet type magnetic circuit 28 for driving the voice coil 24 includes a pot yoke 29 (hereinafter, referred to as “a yoke 29”), a magnet 30, and a pole piece 31. The yoke 29 is made of a magnetic member formed by a pot substructure including a bottom plate portion 29a in a shape of a circular plate and a cylinder portion 29b configured by extending an outer periphery of the bottom plate portion 29a in an axial direction of the vibrating plate 22. The magnet 30 is formed in a shape of a circular plate, and both faces of which are magnetized. One magnetized face of the magnet is closely attached to the bottom plate portion 29a. The magnet 30 is mounted to an inside of the yoke 29. The pole piece 31 has a circular-plate shape by a magnetic member. The pole piece 31 is closely attached to other magnetized face of the magnet 30 at the inside of the yoke 29. A magnetic gap s is formed between an outer peripheral portion thereof and the cylinder portion 29b. The voice coil 24 is inserted into the magnetic gap s.

A characteristic of the inner magnet type magnetic circuit 28 resides in mounting a repulsive magnet 33 both faces of which are magnetized in polarities reverse to those of the magnet 30 on a surface of the pole piece 31 on a side of the vibrating plate as an improvement measure for promoting an efficiency of the magnetic circuit by reducing a leakage magnetic flux from the magnet 30 to the side of the vibrating plate 22.

### SUMMARY

In the inner magnet type magnetic circuit, it is conceivable to mount the repulsive magnet described in JP-A-2002-78081 in addition to mounting the short-circuit ring described in JP-A-2003-199189 so as to increase the efficiency of the magnetic circuit not only by reducing the magnetic distortion by the nonlinearlity of the permeability but also reducing the leakage magnetic flux to the side of the vibrating plate.

However, according to a structure of mounting the short-circuit ring 13 to the outer peripheral portion of the pole piece 11 as in JP-A-2003-199189 mentioned above, a vacant space above the pole piece is reduced by mounting the short-circuit ring 13 and therefore, an outer diameter of the repulsive magnet 33 needs to be restricted to be small such that the repulsive magnet 33 does not interfere with the short-circuit ring 13.

Further, when the outer diameter of the repulsive magnet 33 is reduced, a magnetic intensity in the side of the magnetic gap s by the repulsive magnet 33 is reduced and therefore, an inherent function of the repulsive magnet 33 of reducing the leakage magnetic flux to the side of the vibrating plate cannot sufficiently be achieved, as a result, there poses a problem that an initial object of increasing the efficiency of the magnetic circuit cannot be achieved.

There is a problem that when a reduction in the magnetic distortion is achieved by mounting the short-circuit ring, the outer diameter of the repulsive magnet mounted on the pole piece needs to be reduced, and an increase in the efficiency of the magnetic circuit by mounting the repulsive magnet cannot sufficiently be achieved.

The present invention has been made in view of the above circumstances and provides a speaker apparatus. According to an aspect of the present invention,

According an aspect of the invention, there is provided a speaker apparatus including: an inner magnet type magnetic circuit for driving a voice coil connected to a vibrating plate, the magnetic circuit comprising; a yoke being made of a magnetic member, the yoke comprising a bottom plate portion having a circular-plate shape and a cylinder portion extending an outer periphery of the bottom plate portion in an axial direction of the vibrating plate; a magnet at least partly mounted at an inside of the yoke, the magnet having a circular-plate shape, both faces of the magnet being magnetized, a magnetized face of the magnet being attached to the bottom plate portion of the yoke; and a pole piece having a circular-plate shape, the pole piece being formed of a magnetic member and attached to the other magnetized face of the magnet at an inside of the yoke, a magnetic gap being formed between an outer peripheral portion of the pole piece and the cylinder portion of the yoke, the voice coil inserted into the magnetic gap; a repulsive magnet both faces being magnetized to polarities reverse to a polarity of the magnet and attached on a surface thereof of a vibrating plate side of the pole piece; and a short-circuit ring made of copper, the short-circuit ring mounted and fitted to an inner peripheral portion of a front end of the cylinder portion of the yoke.

### BRIEF DESCRIPTION OF THE DRAWINGS

FIG. 1 is a vertical sectional view of a related-art speaker apparatus having an inner magnet type magnetic circuit.

FIG. 2 is a vertical sectional view of another related-art speaker apparatus having an inner magnet type magnetic circuit.

FIG. 3 is an exemplary vertical sectional view of a speaker apparatus according to a first embodiment.

FIG. 4 is an exemplary vertical sectional view enlarging a yoke and a short-circuit ring of an inner magnet type magnetic circuit shown in FIG. 3.

FIG. 5 is an exemplary enlarged view of portion A of FIG. 3.

FIG. 6 is an exemplary vertical sectional view of a speaker apparatus according to a second embodiment.

FIG. 7 is an enlarged view of portion B of FIG. 6.

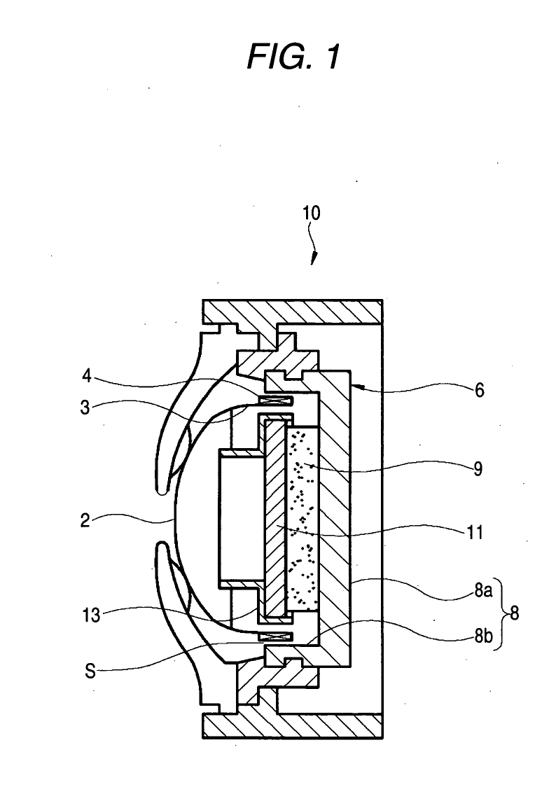

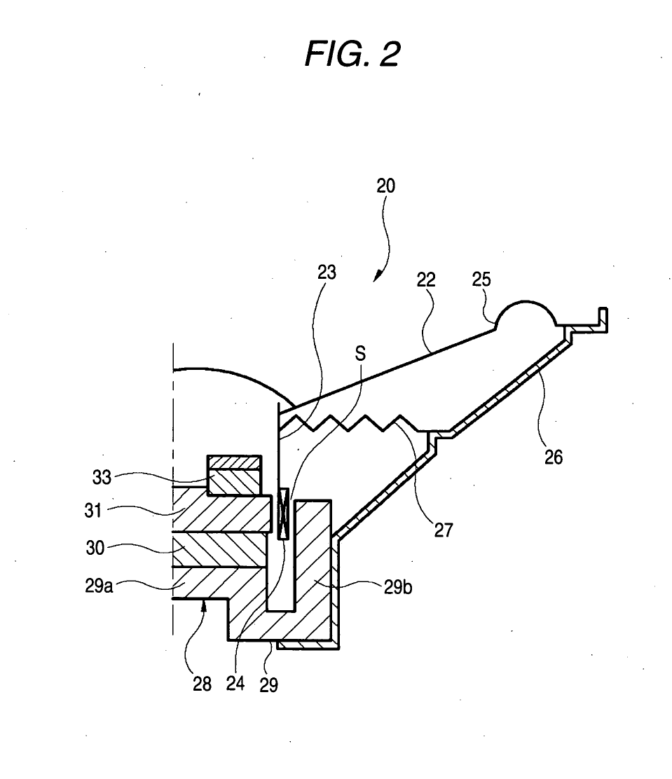

### DESCRIPTION OF THE EMBODIMENTS

### First Embodiment

An explanation will be given of a speaker apparatus according to a first embodiment of the invention in reference to the drawings as follows.

A speaker apparatus 40 adopts a vibrating plate 42 of a dome type. A voice coil 44 is wound around an outer periphery of a voice coil bobbin 43 connected to an outer peripheral edge of the vibrating plate 42. The outer peripheral edge of the vibrating plate 42 is bonded with an edge 45. The outer peripheral edge of the edge 45 is fixed to a speaker frame 48 by being pinched by a ring holder 46 and an edge holder 47.

The speaker frame 48 is configured by a bottom wall portion 48a disposed on a back side of the vibrating plate 42, a peripheral wall portion 48b substantially in a cylindrical shape formed by being extended from an outer periphery of the bottom wall portion 48a to a front side (side of vibrating plate 42), and a flange portion 48c expanded to an outer side in a diameter direction from a front end of the peripheral wall portion 48b.

The bottom wall portion 48a of the speaker frame 48 is fixed with an inner magnet type magnetic circuit 51 for driving the voice coil 44.

The inner magnet type magnetic circuit 51 includes a pot yoke 52 (hereinafter, referred to as “a yoke 52”) made of a magnetic member, a magnet 55 arranged at an inside of the yoke 52, a pole piece 56 arranged on the magnet 55 to be attached thereto, a repulsive magnet 57, for promoting an efficiency of the magnetic circuit by reducing leakage magnetic flux to a side of the vibrating plate 42, and a short-circuit ring 58 for reducing magnetic distortion by nonlinearlity of a permeability.

The yoke 52 is formed of a magnetic member. In the pot type structure of the yoke 52, a bottom plate portion 52a in a shape of a circular plate, and a cylinder portion 52b formed by extending an outer periphery of the bottom plate portion 52a in an axial direction of the vibrating plate 42 (direction along a center axis 53), and the bottom plate portion 52a is fixed to the bottom wall portion 48a of the speaker frame 48 by adhering or the like. The bottom plate portion 52a of the yoke 52 is formed with an opening 52c for inserting a pole 48d formed to be raised at a center of the bottom wall portion 48a of the speaker frame 48.

The magnet 55 has a circular-plate shape. A center of the magnet 55 is formed with an opening 55a for inserting the pole 48d, and both faces of the magnet 55 are magnetized. One of the magnetized faces is closely attached to the bottom plate portion 52a of the yoke 52. The magnet 55 is fixed to an inside of the yoke 52 by adhering or the like.

The pole piece 56 has a circular-plate shape. The pole piece 56 is made of a magnetic member. The pole piece 56 is adhered to be fixed onto other magnetized face of the magnet 55 at the inside of the yoke 52, and partitions a magnetic gap s into which the voice coil 44 is inserted between an outer peripheral portion thereof and the cylinder portion 52b and the yoke 52. A center of the pole piece 56 is formed with an opening 56a for inserting the pole 48d.

According to the first embodiment, although the repulsive-magnet 57 is constituted by a shape of a circular plate similar to the magnet 55, both faces thereof are magnetized in polarities reverse to those of the magnet 55 and fixed to be mounted onto a surface of the pole piece 56 in a side of the vibrating plate 42 by adhering or the like.

Further, the magnetized face of the repulsive magnet 57 on the side of the vibrating plate 42 is adhered with a top plate 59 formed in a shape of a circular plate as a sound absorbing member.

As shown by FIG. 4, the short-circuit ring 58 is integrally formed with a cylindrical portion 58a fitted to an inner periphery of the cylinder portion 52b of the yoke 52, and a fold back portion 58b in a flange-like shape expanded from a front end of the cylindrical portion 58a to an outer side in a diameter direction by pressing a copper plate or the like, and is fitted to be mounted to an inner peripheral portion of the front end of the cylinder portion 52b of the yoke 52.

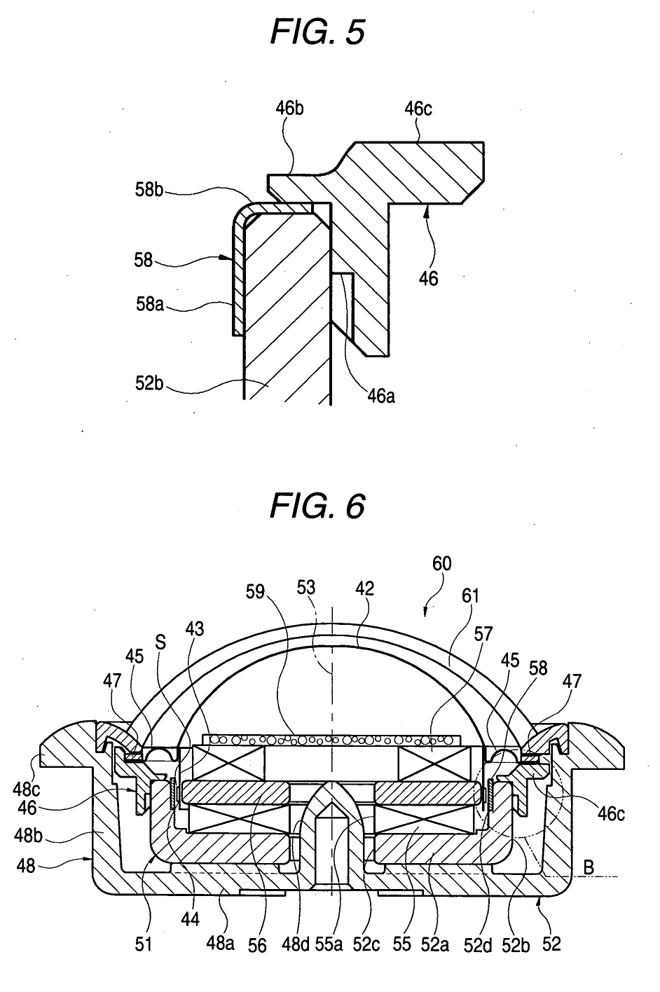

When the short-circuit ring 58 is fitted to be mounted to the inner peripheral portion of the front end of the cylinder portion 52b of the yoke 52, as shown by FIG. 5, the fold back portion 58b is mounted onto a front end face of the cylinder portion 52, so that the short-circuit ring 58 is positioned in an axial direction.

As shown by FIG. 5, the ring holder 46 includes a cylinder portion 46a fitted to an outer periphery of the cylinder portion 52b of the yoke 52, a hold piece 46b extended to an inner side in a diameter direction from an upper end of the cylinder portion 46a, and an edge supporting portion 46c extended to an outer side in a diameter direction from the upper end of the cylinder portion 46a and is formed by being integrally molded by a resin material or the like.

When the ring holder 46 is fitted to be mounted onto the cylinder portion 52b, the ring holder 46 pinches the fold back portion 58b of the short-circuit ring 58 mounted onto the front end face of the cylinder portion 52b to fix the short-circuit ring 58.

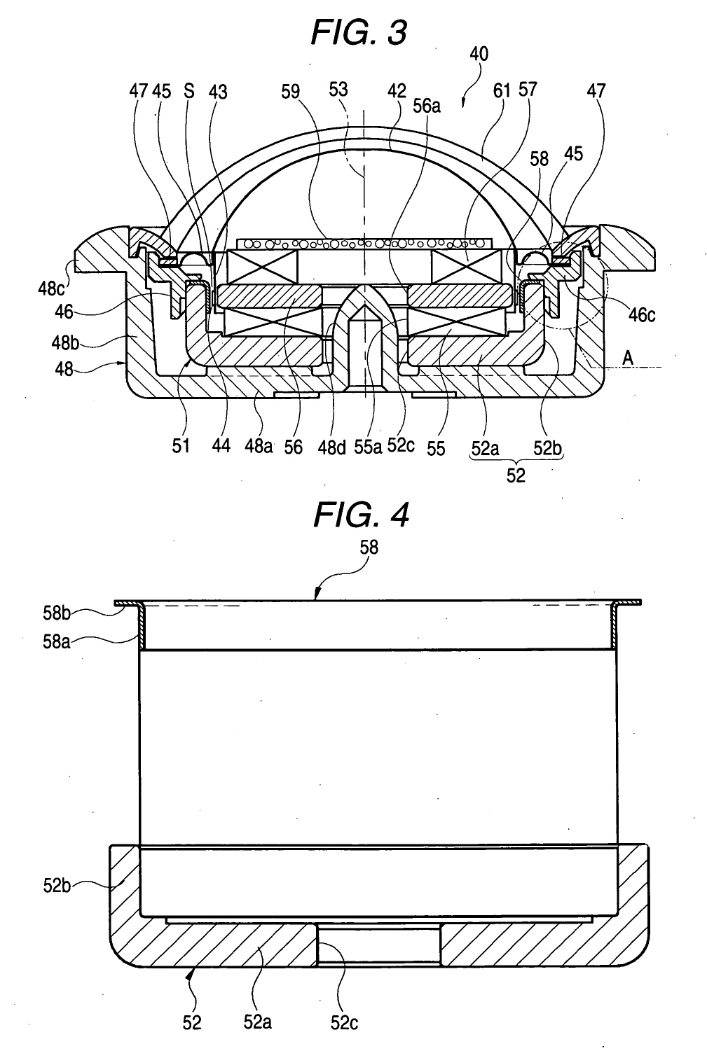

As shown by FIG. 3, an outer peripheral edge of the edge 45 is mounted onto the edge supporting portion 46c of the ring holder 46. The edge 45 is fixed by being pinched by the edge holder 47 in a ring-like shape mounted onto an outer peripheral edge thereof and the edge supporting portion 46c.

As shown by FIG. 3, an inner peripheral portion of the flange portion 48c disposed on a front end side of the speaker frame 48 is coupled with a diffuser 61 extended to a front side of the vibrating plate 42, protecting the vibrating plate 42 against an external force, at the same time, improving an acoustic property.

According to the inner magnet type magnetic circuit 51 of the speaker apparatus 40 explained above, the short-circuit ring 58 is arranged not on the pole piece 56 but at the inner peripheral portion of the front end of the cylinder portion 52b of the yoke 52 and therefore, the short-circuit ring 58 does not prevent the repulsive magnet 57 from being mounted onto the pole piece 56. Therefore, when the short-circuit ring 58 is mounted, a diameter of the repulsive magnet 57 can be enlarged until an outer diameter thereof becomes substantially equal to an outer diameter of the pole piece 56.

As a result, according to the inner magnet type magnetic circuit 51 of the speaker apparatus 40 of the first embodiment, the magnetic distortion can be reduced by mounting the short-circuit ring 58, at the same time, an effect of the repulsive magnet 57 of increasing the efficiency of the magnetic circuit by reducing the leakage magnetic flux in the side of the vibrating plate 42 can maximally be achieved, and both of high efficiency formation and high quality formation of the speaker apparatus 40 can be achieved.

Further, according to the inner magnet type magnetic circuit 51 of the first embodiment, the short-circuit ring 58 includes the cylindrical portion 58a fitted to the inner periphery of the cylinder portion 52b of the yoke 52, and the fold back portion 58b expanded from the front end of the cylindrical portion 58a to the outer side in the diameter direction, the short-circuit ring 58 is positioned in the axial direction by mounting the fold back portion 58b to the front end face of the cylinder portion 52b of the yoke 52.

Therefore, in assembling the inner magnet type magnetic circuit 51, the short-circuit ring 58 can easily be positioned to promote a performance of assembling the inner magnet type magnetic circuit 51.

### Second Embodiment

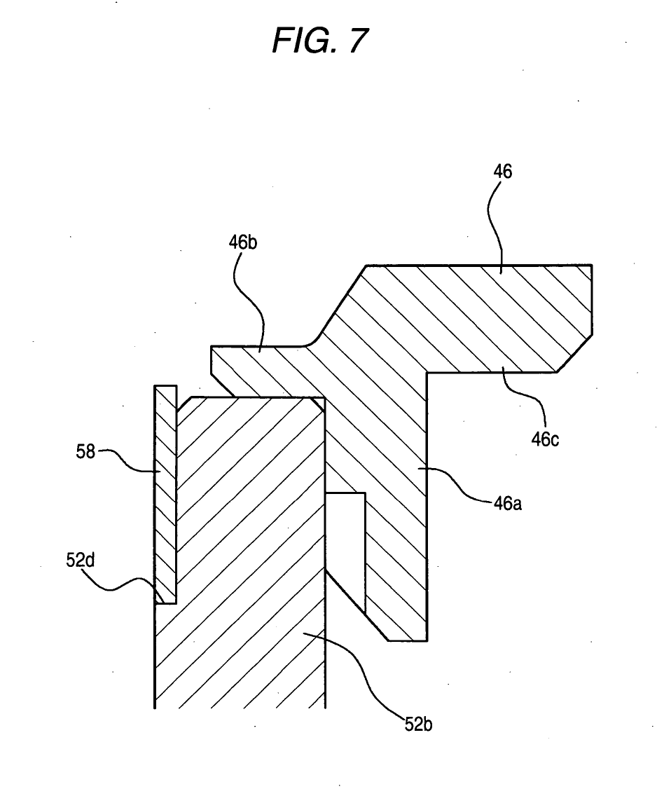

As shown by FIG. 7, a speaker apparatus 60 of a second embodiment which differs from the speaker apparatus 40 of the first embodiment in a following configuration. The inner periphery of the front end side of the cylinder portion 52b of the yoke 52 is formed with a step portion (hereinafter, referred to as “a stepped difference”) 52d for butting an end face of the short-circuit ring 58 fitted to the cylinder portion 52b. By butting the end face of the short-circuit ring 58 to the stepped difference 52d, the short-circuit ring 58 is positioned in the axial direction.

Any part of the short-circuit ring 58 other than the stepped difference 52d may be common to the first embodiment. In the second embodiment the common constitution is attached with the same numeral and an explanation thereof will be omitted.

According to the structure of positioning the short-circuit ring 58 in the second embodiment, the short-circuit ring 58 can be configured by a simple cylindrical structure which is not mounted with the fold back portion 58b shown in the first embodiment, and the short-circuit ring 58 is easy to be worked and produced.

Although the speaker apparatus shown in the above-descried respective embodiments use the vibrating plate of the dome type. However, the embodiments are applicable to a speaker apparatus using a vibrating plate of a cone type.

Further, the embodiments are applicable to a speaker apparatus for a speaker apparatus for vehicle-mounted use, a household use, or for a theater or the like.

According to the above-embodiments, the short-circuit ring 58 does not constitute any hindrance in mounting the repulsive magnet 57 onto the pole piece 56. Therefore, even in the constitution of mounting the short-circuit ring 58, the diameter of the repulsive magnet 57 can be enlarged until the outer diameter becomes substantially equal to the outer diameter of the pole piece 56.

As a result, according to the inner magnet type magnetic circuit 51 of the speaker apparatus 40 of the embodiment, the magnetic distortion can be reduced by mounting the short-circuit ring 58, at the same time, the effect of the repulsive magnet 57 of increasing the efficiency of the magnetic circuit by reducing the leakage magnetic flux to the side of the vibrating plate 42 can maximally be achieved, and both of high efficiency formation and high quality formation of the speaker apparatus 40 can be achieved.

According to the above-embodiments, the short-circuit ring is arranged not on the pole piece but at the inner peripheral portion of the front end of the cylinder portion of the yoke and therefore, the short-circuit ring does not constitute any hindrance in mounting the repulsive magnet onto the pole piece. Therefore, even in a constitution of being mounted with the short-circuit ring, a diameter of the repulsive magnet can be enlarged until an outer diameter thereof becomes substantially equal to an outer diameter of the pole piece.

As a result, according to the inner magnet type magnetic circuit of the speaker apparatus of the embodiments, magnetic distortion can be reduced by mounting the short-circuit ring. At the same time, the effect of the repulsive magnet of increasing an efficiency of the magnetic circuit by reducing leakage magnetic flux to a side of the vibrating plate can maximally be achieved, and both of high efficiency formation and high quality formation of the speaker apparatus can be achieved.

According to the above-embodiments, the short-circuit ring may include a cylindrical portion fitted to an inner periphery of the cylinder portion of the yoke, and a fold back portion extended from a front end of the cylindrical portion to an outer side in a diameter direction and is positioned in the axial direction by being mounted onto a front end face of the cylinder portion.

Thereby, the short-circuit ring is positioned easily and a performance of integrating the inner magnet type magnetic circuit is promoted.

According to the above-embodiments, an inner periphery on the front end side of the cylinder portion of the yoke may be formed with a stepped difference for butting an end face of the short-circuit ring fitted to the cylinder portion, and the short-circuit ring is positioned in the axial direction by butting the end face to the stepped difference.

When such a constitution is constructed the short-circuit ring can be constituted by a simple cylinder structure which is not mounted with the fold back portion or the like and the short-circuit ring is easily worked and produced.

What is claimed is:

1. A speaker apparatus comprising:
an inner magnet type magnetic circuit for driving a voice coil connected to a vibrating plate, the magnetic circuit comprising;
a yoke being made of a magnetic member, the yoke comprising; a bottom plate portion having a circular-plate shape and a cylinder portion extending an outer periphery of the bottom plate portion in an axial direction of the vibrating plate;
a magnet at least partly mounted at an inside of the yoke, the magnet having a circular-plate shape, both faces of the magnet being magnetized, a magnetized face of the magnet being attached to the bottom plate portion of the yoke; and
a pole piece having a circular-plate shape, the pole piece being formed of a magnetic member and attached to the other magnetized face of the magnet at an inside of the yoke, a magnetic gap being formed between an outer peripheral portion of the pole piece and the cylinder portion of the yoke, the voice coil inserted into the magnetic gap;
a repulsive magnet both faces being magnetized to polarities reverse to a polarity of the magnet and attached on a surface thereof of a vibrating plate side of the pole piece; and
a short-circuit ring made of copper, the short-circuit ring mounted and fitted to an inner peripheral portion of a front end of the cylinder portion of the yoke.

2. The speaker apparatus according to claim 1, wherein the short-circuit ring comprises:
a cylindrical portion fitted to an inner periphery of the cylinder portion of the yoke; and
a fold back portion extended from the front end of the cylindrical portion to an outer side in a diameter direction, and
wherein the short-circuit ring is positioned in an axial direction thereof by being mounted onto the front end face of the cylinder portion of the yoke.

3. The speaker apparatus according to claim 1, wherein an inner periphery on the front end side of the cylinder portion of the yoke is formed with a step portion butting an end face of the short-circuit ring fitted to the cylinder portion, and
wherein the short-circuit ring is positioned in the axial direction thereof by butting the end face to the step portion.
